(19) United States
(12) Patent Application Publication
(10) Pub. No.: US 2014/0061552 A1
(43) Pub. Date: Mar. 6, 2014

(54) PLASTIC-BASED COMPOSITE MATERIAL CAPABLE OF CONDUCTING ELECTRICITY AND SHIELDING ELECTROMAGNETIC WAVE AND PREPARATION METHOD THEREOF

(71) Applicant: Bin Zeng, Guangzhou (CN)

(72) Inventor: Bin Zeng, Guangzhou (CN)

(21) Appl. No.: 13/990,947

(22) PCT Filed: Jul. 6, 2011
(86) PCT No.: PCT/CN2011/076918

§ 371 Date: May 31, 2013

(30) Foreign Application Priority Data
May 25, 2011 (CN) 201110137055.3

(51) Int. Cl. H01B 1/24

(52) U.S. Cl. CPC H01B 1/24
USPC 252/519.33

(57) ABSTRACT

Disclosed in the invention is a plastic-based composite material capable of conducting electricity and shielding electromagnetic wave. The plastic-based composite material is prepared from the following raw materials in parts by mass: 40 to 80 parts of plastic matrix, 5 to 15 parts of surface modified high-efficiency conductive agent, 10 to 40 parts of ferroferric oxide, 5 to 10 parts of compatibilizer, and 0.5 to 1 part of antioxidant. The product has good conductive property and mechanical properties, can shield the electromagnetic wave in a high degree, and can be widely applied to the fields of electronic consumer goods, remote monitoring/communication, military, and field/indoor power supply.

### FIELD OF THE INVENTION

The invention relates to a plastic-based composite material capable of conducting electricity and shielding electromagnetic wave and a preparation method thereof.

### BACKGROUND OF THE INVENTION

Various electronic products including household appliances, office electric appliances, and instruments and equipment etc. have been widely popularized and applied with the development of the electronic industry, which brings about convenience to people while releasing a great deal of electromagnetic radiation that endangers people's health.

Therefore, people are looking for composite materials with better electromagnetic wave-shielding performance. Thanks to relatively low densities and relatively low costs, plastic-based composite materials capable of conducting electricity and shielding electromagnetic wave are gradually concerned by the society, and people are looking for various methods to modify plastics, e.g. addition of electrically-conductive metal powder, and electrically-conductive mica powder into plastic matrices to obtain composite materials with corresponding functions. However, the finally-obtained composite materials generally have bad shielding performance and bad mechanical properties etc. due to compatibilities between electrically-conductive particles and the plastic matrices, dispensability of the electrically-conductive particles, processing conditions and other problems.

### SUMMARY OF THE INVENTION

The purpose of the invention is to provide a plastic-based composite material capable of conducting electricity and shielding electromagnetic wave.

The technical scheme applied by the invention is described as follows:

a plastic-based composite material capable of conducting electricity and shielding electromagnetic wave is prepared from the following raw materials in parts by mass: 40 to 80 parts of plastic matrix, 5 to 15 parts of surface modified high-efficiency conductive agent, 10 to 40 parts of ferroferric oxide, 5 to 10 parts of compatibilizer, and 0.5 to 1 part of antioxidant.

The plastic matrix is one of BOPP, PET, PBT and PP.

The compatibilizer is PP-g-MAH.

The antioxidant is at least one of 1010, 1135 and 168.

A preparation method of a plastic-based composite material capable of conducting electricity and shielding electromagnetic wave comprises the following steps:

1) mixing a plastic matrix, a compatibilizer and ferroferric oxide uniformly;

2) mixing the material obtained in Step 1) with a surface modified high-efficiency conductive agent and an antioxidant uniformly;

3) extruding the material obtained in Step 2) by an extruder.

The invention has the following beneficial effect: the product of the invention has good conductive property and mechanical properties, can shield the electromagnetic wave in a high degree, and can be widely applied to the fields of electronic consumer goods, remote monitoring/communication, military, and field/indoor power supply.

### DETAILED DESCRIPTION OF THE PREFERRED EMBODIMENTS

A preparation method of a plastic-based composite material capable of conducting electricity and shielding electromagnetic wave comprises the following steps:

1) mixing a plastic matrix, a compatibilizer and ferroferric oxide for 2 to 3 minutes in a mixer;

2) mixing the material obtained in Step 1) with a surface modified high-efficiency conductive agent and an antioxidant for 2 to 3 minutes in a mixer;

3) extruding the material obtained in Step 2) by a co-rotating twin screw extruder, wherein the length-diameter ratio of the screws of the extruder is 1:30 to 40 and the temperature of the extruder is 180 to 200 degrees centigrade.

When the composite material is prepared by formulations in the following embodiments, the temperature of the extruder is 180 to 200 degrees centigrade from the first embodiment to the sixth embodiment, 230 to 245 degrees centigrade in the seventh embodiment, and 270 to 285 degrees centigrade in the eighth embodiment.

PP-g-MAH is prepared (through in-situ melting grafting, and the preparation technique is a technique known in the art), the grafting ratio of MAH is measured as 1.8% finally.

The formulations of the invention will be further described in combination with the embodiments below.

### Embodiment 1

The formulation composition of a plastic-based composite material capable of conducting electricity and shielding electromagnetic wave is listed as in following Table 1:

TABLE 1
Table 1: formulation composition of a plastic-based composite material
capable of conducting electricity and shielding electromagnetic wave

| Raw material | Parts by mass |
|---|---|
| PP | 40 |
| PP-g-MAH | 5 |
| Ferroferric oxide | 40 |
| Surface modified high-efficiency | 15 |
| conductive agent | |
| Antioxidant 1010 | 0.5 |

### Embodiment 2

The formulation composition of a plastic-based composite material capable of conducting electricity and shielding electromagnetic wave is listed as in following Table 2:

TABLE 2
Table 2: Formulation composition of a plastic-based composite material
capable of conducting electricity and shielding electromagnetic wave

| Raw material | Parts by mass |
|---|---|
| PP | 45 |
| PP-g-MAH | 5 |
| Ferroferric oxide | 40 |
| Surface modified high-efficiency | 15 |
| conductive agent | |
| Antioxidant 168 | 0.5 |

### Embodiment 3

The formulation composition of a plastic-based composite material capable of conducting electricity and shielding electromagnetic wave is listed as in following Table 3:

TABLE 3
Table 3: Formulation composition of a plastic-based composite material
capable of conducting electricity and shielding electromagnetic wave

| Raw material | Parts by mass |
|---|---|
| PP | 50 |
| PP-g-MAH | 5 |
| Ferroferric oxide | 40 |
| Surface modified high-efficiency | 5 |
| conductive agent | |
| Antioxidant 1010 | 0.5 |

### Embodiment 4

The formulation composition of a plastic-based composite material capable of conducting electricity and shielding electromagnetic wave is listed as in following Table 4:

TABLE 4
Table 4: Formulation composition of a plastic-based composite material
capable of conducting electricity and shielding electromagnetic wave

| Raw material | Parts by mass |
|---|---|
| PP | 60 |
| PP-g-MAH | 5 |
| Ferroferric oxide | 30 |
| Surface modified high-efficiency | 5 |
| conductive agent | |
| Antioxidant 168 | 0.5 |

### Embodiment 5

The formulation composition of a plastic-based composite material capable of conducting electricity and shielding electromagnetic wave is listed as in following Table 5:

TABLE 5
Table 5: Formulation composition of a plastic-based composite material
capable of conducting electricity and shielding electromagnetic wave

| Raw material | Parts by mass |
|---|---|
| PP | 60 |
| PP-g-MAH | 5 |
| Ferroferric oxide | 20 |
| Surface modified high-efficiency | 15 |
| conductive agent | |
| Antioxidant 168 | 0.5 |

### Embodiment 6

The formulation composition of a plastic-based composite material capable of conducting electricity and shielding electromagnetic wave is listed as in following Table 6:

TABLE 6
Table 6: Formulation composition of a plastic-based composite material
capable of conducting electricity and shielding electromagnetic wave

| Raw material | Parts by mass |
|---|---|
| BOPP | 45 |
| PP-g-MAH | 6 |
| Ferroferric oxide | 10 |
| Surface modified high-efficiency | 1 |
| conductive agent | |
| Antioxidant 168 | 0.6 |

### Embodiment 7

The formulation composition of a plastic-based composite material capable of conducting electricity and shielding electromagnetic wave is listed as in following Table 7:

TABLE 7
Table 7: Formulation composition of a plastic-based composite material
capable of conducting electricity and shielding electromagnetic wave

| Raw material | Parts by mass |
|---|---|
| PBT | 80 |
| PP-g-MAH | 10 |
| Ferroferric oxide | 30 |
| Surface modified high-efficiency | 12 |
| conductive agent | |
| Antioxidant 1135 | 1 |

### Embodiment 8

The formulation composition of a plastic-based composite material capable of conducting electricity and shielding electromagnetic wave is listed as in following Table 8:

TABLE 8
Table 8: Formulation composition of a plastic-based composite material
capable of conducting electricity and shielding electromagnetic wave

| Raw material | Parts by mass |
|---|---|
| PET | 75 |
| PP-g-MAH | 7 |
| Ferroferric oxide | 27 |
| Surface modified high-efficiency | 8 |
| conductive agent | |
| Antioxidant 1135 | 0.8 |

The properties of the composite materials prepared in the first embodiment to the fifth embodiment are described in the following Table 9:

TABLE 9
Properties of plastic-based composite materials capable of
conducting electricity and shielding electromagnetic wave prepared by the invention

| Property | Unit | Embodiment 1 | Embodiment 2 | Embodiment 3 | Embodiment 4 | Embodiment 5 |
|---|---|---|---|---|---|---|
| Melting index | g/10 min | 15 | 17 | 20 | 22 | 20 |
| Tensile strength | Mpa | 22 | 20 | 20 | 20 | 22 |
| Flexural modulus | Mpa | 2360 | 2170 | 2010 | 1900 | 2100 |
| Charpy impact | KJ/m² | 6.1 | 7.3 | 7.9 | 8.5 | 8.2 |
| Surface | Ω | <10 | <10 | <10 | <10 | <10 |
| resistance | | | | | | |
| Electromagnetic | dB | >60 | >60 | >60 | >60 | >60 |
| shielding | | | | | | |
| efficiency | | | | | | |

In the invention, the surface modified high-efficiency conductive agent is prepared by the following method: mix grapheme (model number: GS-1) and a titanate coupling agent accounting for 1% of grapheme in a high-speed mixer for 2 to 3 minutes.

It can be seen from Table 9 that the product of the invention has good conductive property and mechanical properties and can shield the electromagnetic wave in a high degree. At the same time, the composite material is durable with light specific gravity, and able to form a product with a complex structure, and has other characteristics. The composite material can be widely applied to the fields of electronic consumer goods, remote monitoring/communication, military, and field/indoor power supply, and is completely in conformity with the strategic plan of constructing an economical environment-friendly society in China.

1. A plastic-based composite material capable of conducting electricity and shielding electromagnetic wave,
wherein it is prepared from the following raw materials in parts by mass:
40 to 80 parts of plastic matrix, 5 to 15 parts of surface modified high-efficiency conductive agent, 10 to 40 parts of ferroferric oxide, 5 to 10 parts of compatibilizer, and 0.5 to 1 part of antioxidant,
wherein the surface modified high-efficiency conductive agent is prepared by the following method:
mixing model number GS-1 of grapheme and a titanate coupling agent accounting for 1% of grapheme in a high-speed mixer for 2 to 3 minutes;
the plastic matrix is one of BOPP, PET, PBT and PP; the compatibilizer is PP-g-MAH and the antioxidant is at least one of 1010, 1135 and 168.

2-4. (canceled)

5. A preparation method of a plastic-based composite material capable of conducting electricity and shielding electromagnetic wave, wherein it comprises the following steps:
1) mixing a plastic matrix, a compatibilizer and ferroferric oxide uniformly;
2) mixing the material obtained in Step 1) with a surface modified high-efficiency conductive agent and an antioxidant uniformly; and
3) extruding the material obtained in Step 2) by an extruder.
